(19) United States
(12) Patent Application Publication
(10) Pub. No.: US 2009/0125728 A1
(43) Pub. Date: May 14, 2009

(54) SECURITY METHOD OF SYSTEM BY ENCODING INSTRUCTIONS

(75) Inventors: Jongtae KIM, Gyeonggi-do (KR); Seokmin Yoon, Gyeonggi-do (KR)

Correspondence Address: RABIN & Berdo, PC, 1101 14TH STREET, NW, SUITE 500, WASHINGTON, DC, 20005, US

(73) Assignee: SUNGKYUNKWAN UNIVERSITY FOUNDATION FOR CORPORATE COLLABORATION, Gyeonggi-do (KR)

(21) Appl. No.: 12/027,740

(22) Filed: Feb. 7, 2008

(30) Foreign Application Priority Data
Nov. 14, 2007 (KR) 10-2007-0116182

(51) Int. Cl. H04L 9/28

(52) U.S. Cl. 713/190

(57) ABSTRACT

The provided is a method for securing a system by encoding instructions. The method includes encoding instructions composed by a system developer and storing the encoded instructions through an encoding module during a compiling procedure, and decoding the encoded instructions and executing the decoded instructions through a decoding module. In the method, the instructions are encoded using interdependency between instructions in an instruction set which is composed by a system developer.

The present application claims priority under 35 U.S.C. 119 to Korean Patent Application No. 10-2007-0116182 (filed on Nov. 14, 2007), which is hereby incorporated by reference in its entirety.

### TECHNICAL FIELD

Embodiments relates to a method for securing a system by encoding instructions and, more particularly, to a security method for protecting an embedded system from physical and software attacks that are made by a malicious attackers through executing illegal programs by encoding and decoding instructions using interdependency between instructions, which is temporal relation between instructions.

### BACKGROUND

In general, an embedded system is a special-purpose computer system designed to perform one or few dedicated functions. The embedded system is usually embedded as part of complete device including hardware and mechanical parts. For example, the embedded system is commonly included in various modern electronic, information, and communication devices such as computers, home appliances, automation systems, elevators, and mobile phones.

As an embedded system was advanced to be connectable to the Internet, a security problem thereof has been receiving attention. Most of researches for security problems of the embedded system were focused to develop a technology for protecting an embedded system from software attacks. Relatively, it was difficult to protect the embedded system from hardware attacks. Thus, valuable information has been easily opened to malicious attackers through hardware attacks. As devices for storing, processing information, and communication, such as a mobile phone or a personal digital assistant (PDA) have been popularized, there have been demands for developing a technology for protecting such devices from hardware attacks. Accordingly, it was necessary to develop a security processor that guarantees to secure a system form hardware attacks.

Studies about a security processor of an embodied system have been progressed as a method for individually protecting instructions stored in a memory or as a method for monitoring a flow of execution sequence in a program.

As the related art, a technology for authenticating instructions through performing a hashing process in a unit block using a HMAC algorithm was introduced in an article by A. Murat Fishiran et. al., entitled “Runtime Execution Monitoring (REM) to Detect and Prevent Malicious Code Execution” ICCD, 2004. Also, a technology for detecting a violated instruction by monitoring an execution sequence of instructions was introduced in an article by A. Divay, entitled “Secure Embedded Processing through Hardware-Assisted Run-Time Monitoring”, p. 178-183, 2005. In the technology, an execution sequence of instructors is transformed to a finite state machine (FSM) during a compile procedure before executing the instructions and the FSM is stored in an external field-programmable gate array (FPGA). After storing, the execution flow of instructions is monitored with reference to FPGA, thereby preventing the abnormal execution flow of instructions. However, the technology has a shortcoming that a development procedure of a secured program is very complicated because contents of FPGA must be updated for every program in order to detect branch errors of programs.

Furthermore, securing a system was very dependable to a secret key used for encoding or to a value of a hash function in case of a security processor employing a technology for individually encoding instructions or instruction groups using a hash function or an encoding algorithm or employing a technology for preventing a flow of abnormal instructions by monitoring an execution flow of instructions of a program loaded in a system. If the secret key or the hash value are opened through wiretapping a system bus or hardware attack, the security can be easily broken down.

### SUMMARY

Embodiments have been proposed in order to provide a method for securing a system by encoding instruction, which can improve the security of a system by preventing an abnormal program from being executed in an instruction level by encoding instructions using interdependency between instructions which are temporally related to each others.

Embodiments have been proposed in order to provide a method for securing a system by encoding instructions, which can reduce unnecessary memory overhead and simplify a development procedure of a secured program by encoding instructions using interdependency between instructions which are temporally related to each others.

In order to solve the above problems, embodiments provide a method for securing a system by encoding instructions, which protects a target system from external attacks that execute an illegal program, including: encoding instructions composed by a system developer and storing the encoded instructions through an encoding module during a compiling procedure; and decoding the encoded instructions and executing the decoded instructions through a decoding module, wherein in the encoding instructions, the instructions are encoded using interdependency between instructions in an instruction set which is composed by a system developer.

The interdependency may be generated based on relation among a current instruction of a current time, a previous instruction which is temporally adjacent to the current instruction, and a next instruction which is temporally adjacent to the current instruction.

The current instruction may be encoded using an equation:

C(t)=Ek(I(t),I(t−1),C(t+1)),

where C(t) denotes an encoded current instruction of a current time, E denotes a function for encoding an instruction using a secret key k, I(t) is a current instruction of a current time, I(t−1) is a previous instruction of a past time, and C(t+1) is an next instruction of a future time after encoding.

The function E used for encoding the instructions may be an encoding function or a hash function capable of inverse operation.

A start point and an end point of a program may be encoded by inserting a magic number in a previous memory address adjacent to a memory address storing a first instruction and by inserting a magic number in a next memory address adjacent to a memory address storing a last instruction so as to prevent interdependency between instructions from being broken at the start point and the end point of a program.

Encoding may be performed by inserting a predetermined instruction at a target address of a broach instruction whenever the branch instruction is performed in order to prevent interdependency from being broken at a branch point of a program where the predetermined instruction is an instruction that does not influence a function of the program.

The predetermined instruction not influencing the function of the program may be a no operation (NOP) instruction.

In the decoding the encoded instructions, the encoded instructions may be decoded using interdependency between instructions.

The interdependency may be generated based on relation among a current instruction of a current time, a previous instruction which is temporally adjacent to the current instruction, and a next instruction which is temporally adjacent to the current instruction.

The encoded current instruction may be decoded using an equation:

I(t)=Dk(C(t),I(t−1),C(t+1)),

where I(t) denotes a current instruction of a current time, D denotes a function for decoding an instruction using a secret key k, C(t) denotes an encoded current instruction of a current time, I(t−1) denotes a previous instruction of a past time, and C(t+1) denotes a next instruction after encoding.

The function D used for decoding the encoded instructions may be an encoding function or a hash function capable of inverse operation.

### DRAWINGS

FIG. 1 is a diagram illustrating a security model of an embedded system where the present invention is applied.

FIG. 2 is a block diagram illustrating a structure of an encoding module based security processor according to the related art.

FIG. 3 is a diagram illustrating a program code for describing an execution sequence of a normal program according to a branch instruction.

FIG. 4 is a block diagram illustrating a method for encoding instructions in accordance with an embodiment.

FIG. 5 is a block diagram illustrating a method for decoding instructions in accordance with an embodiment.

FIG. 6 is a diagram for describing a method for overcoming a problem of a start point and an end point of a program in accordance with another embodiment.

FIG. 6 is diagram for describing a method for overcoming a problem of a branch point of a program in accordance with another embodiment.

### DESCRIPTION

Hereinafter, embodiments of the present invention will be described in detail with reference to the accompanying drawings.

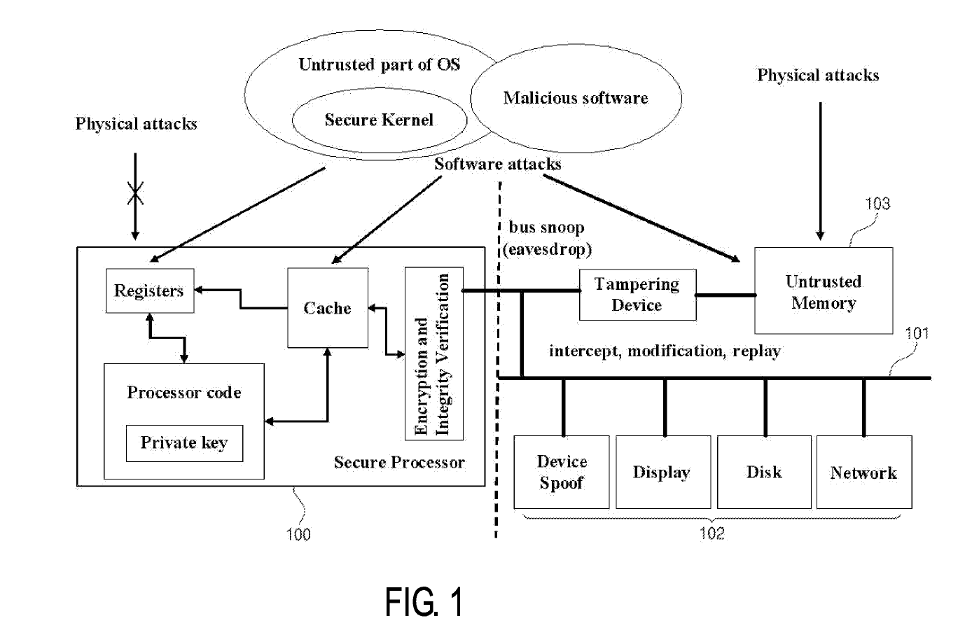

FIG. 1 is a diagram illustrating a security model of an embedded system where the present invention is applied.

As shown in FIG. 1, the embedded system includes a processor 100, an external bus 101, peripheral devices 102, and a memory 103. It is assumed that the external bus 101, the peripheral device 102, and the memory 103 are fragile to both of software and hardware attacks although the processor 100 is very safe against malicious attacks. Here, it is possible to prevent an abnormal program from being generated by sensing violation when an instruction is violated by attacks made to an external peripheral device of a processor by applying a method for securing a system by encoding instructions according to embodiments to a security processor that encodes instructions and performs data integrity.

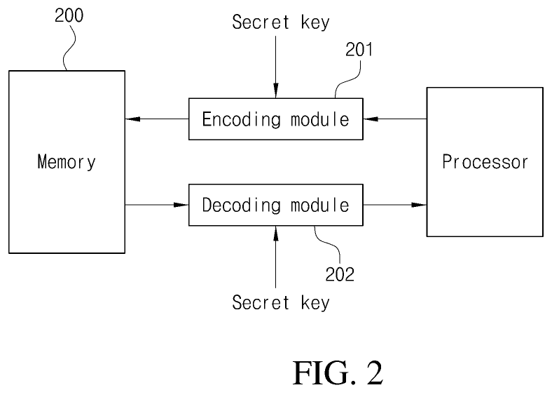

In order to clearly describe a structure of a security processor employing the method for securing a system by encoding instructions, FIG. 2 shows a structure of an encoding module based security processor according to the related art.

As shown in FIG. 2, the security processor according to the related art includes a memory 200, an encoding module 201, a decoding module 202, and a processor. The encoding module 201 encodes an entire program code or a predetermined part of a program code through an encoding algorithm and stores the encoded program in the memory 200. The decoding module 202 decodes the encoded program code to execute a program. That is, the security processor has a structure for dynamically monitoring whether a program is modified or not by encoding a program, storing the encoded program, decoding the encoded program, and executing the decoded program through the memory 200, the encoding module 201, and the decoding module 202.

Although the method for securing a system by encoding instructions according to the embodiment basically follows the structure of the security processor shown in FIG. 2, the method for securing a system is different from the security processor shown in FIG. 2 because an execution sequence of a program is encoded and the encoded execution sequence is verified. That is, the method for securing a system can prevent an abnormal instruction from being executed in advance if a corresponding instruction is an abnormal instruction having broken interdependency to temporal and spatial adjacent instructions by encoding an execution sequence of instructions in a program using interdependency.

The method for securing a system by encoding instructions determines whether an instruction performed in a corresponding system (processor) is normal or not, or determines whether the execution sequence of instructions is normal or not based on following logics.

First step: an instruction performed at a time t−1 is a normal instruction. That is, the instruction is a normal instruction intended by developers. Here, the time t−1 denotes a past time, one time unit behind of a current time.

Second step: an instruction performed at a current time t is an instruction to be performed after an instruction performed at a time t−1. That is, it is an execution sequence intended by developers.

Third step: an instruction scheduled to be performed at a time t+1. It is also an execution sequence intended by developers. Here, a time t+1 denotes a future time that is one time unit after the current time t.

As described above through the first step to the third step, the processor determines whether a currently performing instruction is an normal operation of a program which is intended by developers by continuously determining whether a current instruction has interdependency with a previous instruction or not and whether a current instruction has interdependency with a next instruction or not. Therefore, if the interdependency is broken between temporally adjacent instructions, the processor may determine that the currently performing instruction is an abnormal instruction.

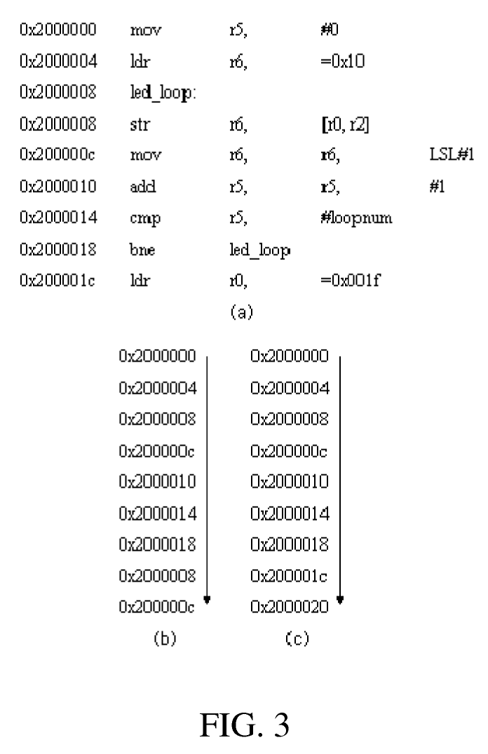

The method for securing a system according to the present embodiment will described with reference to FIG. 3 that shows a program composed of a plurality of instructions. In a normal operation state, the instructions of a program (a) have two execution sequences (b) and (c) according to a result of executing conditional expression of bne which is a branch instruction stored in a memory address 0x2000018. If the other execution sequences excepting the execution sequences (b) and (c) are monitored, it can be determined as violated at an instruction level.

If a processor can determine whether or not a corresponding instruction is modified or whether an instruction is executed in a normal execution sequence or not before each of instructions is executed, it is possible to effectively prevent security threat applied to a system through software and hardware attacks.

The present invention also relates to a method of encoding instructions based on the described concept, which is applied to a security processor. The method of encoding instruction encodes instructions written by system developers through an encoding module and stores the encoded instructions during a compiling procedure, and decodes the encoded instructions through a decoding module. That is, an encoding module according to the present invention encodes instructions using temporal relation between instructions in an instruction set composed by system developers, which is referred as interdependency between adjacent instructions.

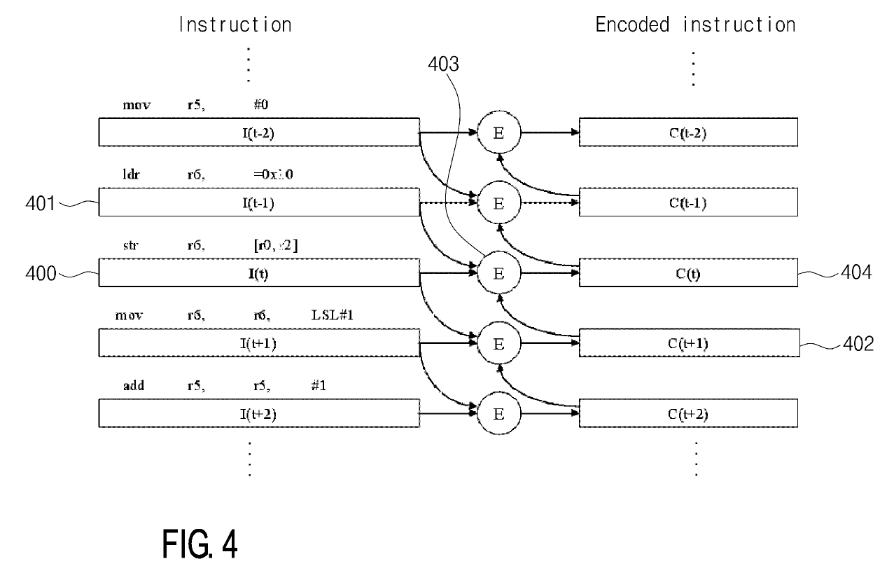

FIG. 4 is a diagram illustrating a method for encoding instructions using interdependency between instructions. In FIG. 4, it is assumed that a processor fetches one instruction at one unit time.

As shown in FIG. 4, an encoding function 403 generates an encoded current instruction 404 by encoding a current instruction 400 based on the interdependency between the current instruction 400, a previous instruction 401 which is temporally adjacent to the current instruction 400, and a next instruction 402 which is temporally adjacent to the current instruction 400.

That is, each instruction may be encoded through following equations based on a current time t.

C(t)=Ek(I(t),I(t−1),C(t+1)) Eq. 1.

In Eq. 1, C(t) denotes an encoded current instruction of a current time, and E denotes a function for encoding an instruction using a secret key k. I(t) is a current instruction of a current time. I(t−1) is a previous instruction of a past time. C(t+1) is an next instruction of a future time after encoding.

For example, the function (E) for encoding instructions may be composed of encoding functions AES or DES and a hash function capable of inverse operation.

The decoding module decodes the encoded instructions, which are encoded based on the interdependency between instructions as described above, using the interdependency between instructions like the encoding module.

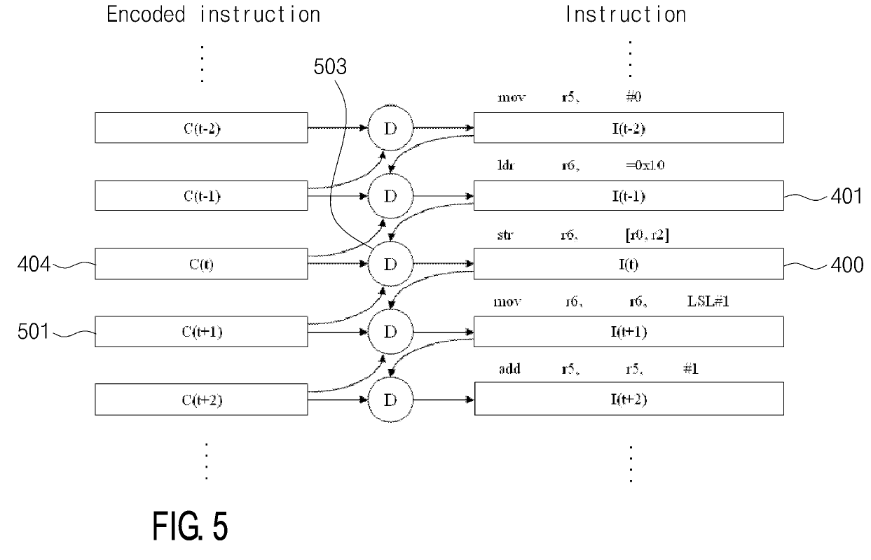

FIG. 5 is a diagram illustrating a procedure of decoding instructions using interdependency between instructions.

As shown in FIG. 5, a decoding function 503 may generate a current instruction 400 of a current time by decoding an encoded current instruction 404 based on the interdependency between the encoded current instruction 404, a previous instruction 401 of a past time, and a next instruction 501 after encoding.

That is, each encoded instruction may be decoded through following Eq. 2 based on a current time t.

I(t)=Dk(C(t),I(t−1),C(t+1)) Eq. 2

In Eq. 2, I(t) denotes a current instruction of a current time, and D denotes a function for decoding an instruction using a secret key k. C(t) denotes an encoded current instruction of a current time, I(t−1) denotes a previous instruction of a past time, and C(t+1) denotes a next instruction after encoding.

For example, the function D for decoding the instructions may be composed of an encoding function such as AES and DES or a hash function capable of inverse operation.

If instructions are encoded and decoded using the interdependency between the temporally adjacent instructions as described above, memory overhead is not generated and a secure program can be simply developed. Furthermore, the method of decoding and encoding instruction prevents instructions from being violated or modified through software attack or hardware attack. Therefore, the security of a target system can be further improved.

For example, it is assumed that a malicious attacker attacks a system employing the security method according to the present embodiment as follows. The malicious attacker modifies a current instruction I(t) by decoding an encoded current instruction C(t), encodes the current instruction C(t) to an instruction C′(t), and stores the instruction C′(t) into a memory. Or, the malicious attacker inserts an instruction into a processor through wiretapping a bus line. If the instructions are encoded using the interdependency of temporally adjacent instructions, it is impossible to normally decode an encoded previous instruction C(t−1) because C(t) used for encoding is modified.

Therefore, the malicious attacker needs to modify a previous instruction I(t−1) by decoding C(t−1), encodes C(t−1) to C′(t−1), and inserts C′(t−1) to a processor in order to enable an intended abnormal program to be executed in a target system. That is, the malicious attacker needs to modify C(t−1) if the malicious attacker modifies C(t), and the malicious attacker needs to modify C(t−2) if the malicious attacker modifies C(t−1). That is, if one instruction is modified, it needs to modify all of instructions encoded from a starting time of attacking to a starting point of a program.

It is impossible to modify previous instructions, which are instructions stored in a pipe line of a processor, at a current time. Therefore, if a predetermined instruction is violated by attack, related instructions will not be normally decoded. Since the instructions are not normally decoded, a program cannot be normally executed. Therefore, a user can be aware of attacks made to a system.

In the present embodiment, interdependency between spatially and temporally adjacent instructions is continuously determined in order to use the interdependency for encoding and decoding instructions. However, the interdependency between instructions may be broken by the nature of a normal program. For example, the interdependency may be broken at a starting point of a program, an end point of a program, and a branch instruction. A malicious attacker may use such a broken point of the interdependency to attack a target system. Hereinafter, a method for securing a system by encoding instructions even if interdependency is broken according to another embodiment will be described.

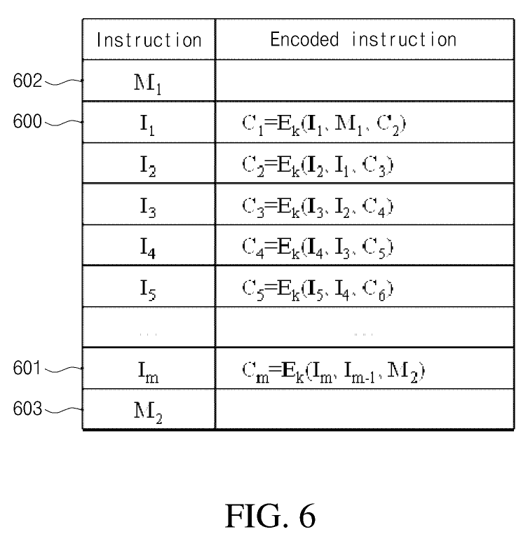

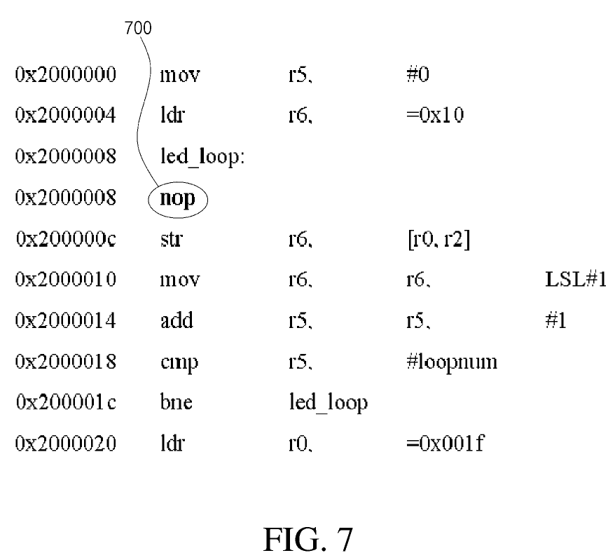

FIG. 6 shows a program composed of a plurality of instructions where interdependency is broken at a start point and an endpoint of the program. The method for securing a system by encoding instructions even if interdependency is broken due to nature of a program itself according to another embodiment will be described with reference to FIG. 6.

As shown in FIG. 6, the interdependency may be broken at the start point 600 and the end point 601 because it is impossible to determine interdependency with a previous instruction at the start point 600 of the program because no previous instruction exists at the start point 600. Also, it is impossible to determine interdependency with a next instruction at the end point 601 of the program because no previous instruction exists at the end point 601. In the present embodiment, a unique number which is only known to a user is inserted when instructions are secured at the start point and the end point of a program in order to overcome the broken independency program. Such a unique number is referred as a magic number.

That is, a start point and an end point of a program are encoded by inserting a magic number into a previous memory address adjacent to a memory address storing the first instruction which is the start point of a program and a next memory address adjacent to a memory address storing the last instruction which is the end point of the program.

As shown in FIG. 6, a program includes m instructions. The first instruction I₁, which is a start point 600 of the program, is encoded using the current instruction I₁, a magic number M₁ 602 of the start point, and an encode code C₂ of a next instruction. The last instruction Iₘ, which is an end point 601 of the program, is encoded using the current instruction Iₘ, a previous instruction Iₘ₋₁, and a magic number M₂ 603 of the end point. As described above, the method of securing a system according to the present embodiment prevents interdependency from being broken using the magic number for the start point and the end point of the program.

Hereinafter, a method for securing a system by encoding instruction when interdependency is broken by a branch instruction in a program according to an embodiment will be described.

The branch instruction is classified into a non-conditional branch instruction and a conditional branch instruction. The non-conditional branch instruction breaks interdependency between instructions by changing a flow of execution sequence to a predetermined address of the program without conditional expression. The conditional branch instruction does not break interdependency when conditional expression is false because the next instruction is performed. The conditional branch instruction breaks interdependency when conditional expression is true because an instruction of another part is executed by changing a flow of execution sequence to a predetermined address of the program.

In order to prevent a branch instruction from breaking interdependency, a predetermined instruction is inserted to a target address of a branch instruction when the branch instruction is executed. Here, the predetermined instruction is an instruction not influencing a function of a program. Preferably, No operation instruction may be inserted as the predetermined instruction.

For example, if a branch instruction bne is included at a memory address 0x2000018 in a program shown in FIG. 3, a related instruction is encoded by inserting a predetermined instruction not influencing a function of the program at the target address of the branch instruction, 0x2000008. FIG. 7 shows the program including the predetermined instruction inserted into the target address. In FIG. 7, a No operation (NOP) instruction 700 is inserted into the target address of the branch instruction.

If a branch instruction is executed after an NOP instruction is inserted to a branching point of a program as described above, the NOP instruction is always executed. Here, the inserted NOP instruction prevents the interdependency from being broken because the inserted NOP instruction has the interdependency with a previous instruction and a next instruction thereof at the branching point. Meanwhile, since the NOP instruction does not have an operand, a comparison procedure may be additionally added by storing a parity at the address thereof.

The insertion of a NOP instruction for processing a branch instruction may be a factor to increase a size of a program. However, it must be considered as an unavoidable overhead for securing a program.

As described above, the method for securing a system according to the present embodiment encodes temporally related instructions using interdependency thereof. Thus, the method for securing a system according to the present embodiment prevents a malicious attacker from executing an abnormal program by violating a predetermined encoded instruction. Therefore, a system can be safely protected from instruction level attacks, and consumers can use portable devices without security threat made by software attack and hardware attack.

It will be apparent to those skilled in the art that various modifications and variations can be made to embodiments without departing from the spirit or scope of the disclosed embodiments. Thus, it is intended that the present invention covers modifications and variations of this invention provided they come within the scope of the appended claims and their equivalents.

The method for securing a system according to the present invention enables a secured program to be simply developed without memory overhead by encoding instructions using interdependency between instructions.

Furthermore, the method for securing a system according to the present invention can prevent an abnormal execution flow of a program as well as individually securing instructions from software or hardware attacks. Therefore, the security of a system may be further improved, thereby enabling users to safely use an embedded system without security threat.

What is claimed is:

1. A method for securing a system by encoding instructions, which protects a target system from external attacks that execute an illegal program, comprising:
encoding instructions composed by a system developer and storing the encoded instructions through an encoding module during a compiling procedure; and
decoding the encoded instructions and executing the decoded instructions through a decoding module,
wherein in the encoding instructions, the instructions are encoded using interdependency between instructions in an instruction set which is composed by a system developer.

2. The method of claim 1, wherein the interdependency is generated based on relation among a current instruction of a current time, a previous instruction which is temporally adjacent to the current instruction, and a next instruction which is temporally adjacent to the current instruction.

3. The method of claim 2, wherein the current instruction is encoded using an equation:
C(t)=Ek(I(t),I(t−1),C(t+1)),
where C(t) denotes an encoded current instruction of a current time, E denotes a function for encoding an instruction using a secret key k, I(t) is a current instruction of a current time, I(t−1) is a previous instruction of a past time, and C (t+1) is an next instruction of a future time after encoding.

4. The method of claim 3, wherein the function E used for encoding the instructions is an encoding function or a hash function capable of inverse operation.

5. The method of claim 3, wherein a start point and an end point of a program are encoded by inserting a magic number in a previous memory address adjacent to a memory address storing a first instruction and by inserting a magic number in a next memory address adjacent to a memory address storing a last instruction so as to prevent interdependency between instructions from being broken at the start point and the end point of a program.

6. The method of claim 3, wherein encoding is performed by inserting a predetermined instruction at a target address of a broach instruction whenever the branch instruction is performed in order to prevent interdependency from being broken at a branch point of a program where the predetermined instruction is an instruction that does not influence a function of the program.

7. The method of claim 6, wherein the predetermined instruction not influencing the function of the program is a no operation (NOP) instruction.

8. The method of claim 1, wherein in the decoding the encoded instructions, the encoded instructions are decoded using interdependency between instructions.

9. The method of claim 8, wherein the interdependency is generated based on relation among a current instruction of a current time, a previous instruction which is temporally adjacent to the current instruction, and a next instruction which is temporally adjacent to the current instruction.

10. The method of claim 9, wherein the encoded current instruction is decoded using an equation:
I(t)=Dk(C(t),I(t−1),C(t+1)),
where I(t) denotes a current instruction of a current time, D denotes a function for decoding an instruction using a secret key k, C(t) denotes an encoded current instruction of a current time, I(t−1) denotes a previous instruction of a past time, and C(t+1) denotes a next instruction after encoding.

11. The method of claim 10, wherein the function D used for decoding the encoded instructions is an encoding function or a hash function capable of inverse operation.
